(19) United States
(12) Patent Application Publication
(10) Pub. No.: US 2008/0217907 A1
(43) Pub. Date: Sep. 11, 2008

(54) Magnetic Card with Improved Adhesive Construction

(76) Inventors: Bruce Dean, Marietta, OH (US); C. Allen Love, Marietta, OH (US)

Correspondence Address: Norris, Jerome, 1901 Pennsylvania Ave NW Ste 305, Washington, DC, 20006, US

(21) Appl. No.: 10/588,224

(22) PCT Filed: Jun. 22, 2004
(86) PCT No.: PCT/US04/20009

§ 371 Date: Aug. 3, 2006

(51) Int. Cl. B42D 15/00

(52) U.S. Cl. 283/82

(57) ABSTRACT

An adhesive-backed magnetizable or magnetic article or card, the improvement wherein the article or card comprises a magnetizable or magnetic base member; a printable sheet material non-magnetic surface affixed to the magnetizable or magnetic base member; an adhesive layer containing a plurality of non-adhesive voids or openings to facilitate ease of peel and non-marring of the printable sheet material; and a backing or liner layer non-permanently bonded to the adhesive layer.

### BACKGROUND OF THE INVENTION

1. Field of the Invention

The present invention relates to a magnetic article, device or card, sometimes known as a refrigerator magnet, with an easy peel adhesive backing or release liner to facilitate ease of peel and non-marring of the contact surface in one configuration or ease of peel by virtue of a “tab” of liner on an adhesive backing in another configuration. More particularly, the present invention relates to a magnetic article of card with an easy-peel adhesive backing, wherein the adhesive backing contains a plurality of non-adhesive voids or openings therein to facilitate ease of peel and non-marring of the contact surface or ease of peel of a release liner on an adhesive backing containing a plurality of non-adhesive voids or openings. The magnetic article or card is preferably a one-piece unitary construction that is extremely simple and therefore more user friendly due to greater ease of peeling away the adhesive backing.

2. The Prior Art

Small magnets with printed material on one surface are very popular with consumers for use as refrigerator magnets to hold various items such as childrens art work, bills to be paid, business cards, cartoons and advertisements.

In general, from the commercial perspective, magnets having advertising printed on their surface are valued by businesses as they provide good exposure to the advertiser whenever the consumer views or uses the magnet.

Nevertheless, a significant problem extant in connection with magnetic cards with adhesive backing is the difficulty of removing the adhesive backing or release liner. For example, in the case of a label for attachment to a substrate, wherein the label consists of a magnetic article having a first surface with a printed material attached to the first surface of the magnet, a clear film separable from the printed material on the first surface, an adhesive backing attached to the clear film and a liner material covering the adhesive backing, upon removal of the liner material, difficulty is occasioned in easily and cleanly removing the adhesive backing, thereby rendering removal of the adhesive backing non-user friendly.

U.S. Pat. No. 6,472,037 disclose a non-permanent adhesive-backed magnetized securing device that facilitates attaching and detaching objects from the adhesive portion of the magnetized securing device—and serves to reduce any damage to the contacted surface of the objects. The device includes a base member and a non-permanent adhesive connected to the base member. FIGS. 1, 2 and 4 depict the non-permanent adhesive-backed magnetized securing device 10 for removably securing an object 12. The securing device 10 generally comprises a base or first member 14 and a non-permanent adhesive 16.

A label for attachment to a substrate, including a flexible magnet having printed material on one surface is disclosed in U.S. Pat. No. 6,153,279. The label consists of a thin, flat, flexible magnet having a first surface and a second surface, printed material attached to the first surface of the flexible magnet, a transparent covering attached to the printed material, a clear base material attached to the second surface of the magnet, a clear film easily separable from the clear base material, an adhesive backing attached to the clear film, and a liner material covering the adhesive backing. The liner material may be removed from the adhesive backing whereby the label may be applied to a substrate by means of the adhesive backing. After separating the clear film and clear base material, the clear base material covers the second surface of the magnet and the clear film covers the adhesive backing applied to the substrate. FIGS. 1 and 2 show the label 10 which includes a thin, flat, flexible magnet 12, printed material 14 attached to a first surface 16 of the magnet 12, a transparent covering 18 attached to the printed material 14, a clear base material 20 attached to a second surface 22 of the magnet 12, a clear film 24 easily separable from the clear base material 20, an adhesive backing 26 attached to the clear film 24, and a liner 28 covering the adhesive backing 26.

U.S. Pat. No. 6,302,363 disclose a magnetic device for holding a thin non-magnetic sheet material against a flat, smooth, magnetically attractive metallic surface. It comprises a one-piece hard unitary body having a first bottom planar magnetic surface and at least one other adjoining bottom planar magnetic surface and these magnetic surfaces may be permanently bonded, as by an adhesive. The magnetic surfaces are joined along a common bend line at an obtuse angle. The bend line functions as a fulcrum whereby manual force applied to the top surface of the unitary body caused the bottom magnetic surfaces to be alternately engageable with a magnetically attractive surface, such as a refrigerator door, in direct contact with the door and through non-magnetic sheet material to be attached to the door. As shown in FIGS. 1 to 3, a magnetic sheet material having planar magnetic surfaces 14 and 15 is co-extensive in size with the non-magnetic body segments 11 and 12.

A magnetic self-stick pad, as can be best be seen in FIG. 7, which is a flexible magnetic layer 32 having or being bonded to an adhesive layer 26 and an adhesive bottom side 26 is disclosed in U.S. Pat. No. 6,431,513. The top adhesive side 26 has a layer of an appropriate bonding agent holding a graphics layer 30 thereto. The bottom side of the magnetic substance has a bonding or agent or adhesive layer 26 affixed thereto having a peelably removable protective element 24, e.g., paper.

U.S. Pat. No. 5,680,709 disclose an alignment device for aligning and registering a display panel onto an adhesive backing panel, wherein the backing panels may include a removable protective sheet on the adhesive layer and a magnetic strip. The card device comprises:

(a) a base adapted to be placed on a support surface;

(b) two upstanding wall portions disposed on and extending upwardly from the base and oriented along a boundary of an imaginary area within the base that is geometrically congruent with the display panel and the backing panel, the wall portions skewed with respect to one another to define limit stops against which the display panel and the backing panel are adapted to be simultaneously placed such that movement in at least two degrees of motion by the display panel and backing panel is prevented thereby enabling proper registration of the display panel onto the backing panel; and

(c) the base having an arcuate cut-out along its perimeter with the cut-out extending from the perimeter to a location within the imaginary area.

There is a need when using magnetic cards with adhesive backing to obtain: A) easy removal of the adhesive; no residual adhesive left-over; and no marring of the surface of the printed label affixed to the underlying magnet—or: B) ease of peel of a release liner on an adhesive backing affixed to a magnet.

### SUMMARY OF THE INVENTION

One object of the present invention is to provide a magnetizable or magnetic card with the adhesive in a novel form, with characteristics that allow the adhesive to be easily removable from a printed label affixed to the magnetizable or magnetic card without marring the surface of the printed label affixed to the magnetizable or magnetic material.

Another object of the present invention is to provide a magnetizable or magnetic card with an adhesive layer thereon containing a plurality of openings or voids therein so that a “tab” of liner is formed on a release liner disposed on top of the adhesive to permit easy peel of the release liner.

A further object of the present invention is to provide a magnetizable or magnetic card wherein the adhesive is formed with a plurality of openings or voids therein to allow the adhesive to be easily removable from a printed label affixed to the magnetizable or magnetic card without marring the surface of the printed label affixed to the magnetizable or magnetic material.

The foregoing and other objects of the present invention will be more readily apparent upon reference to the brief description of the drawing figures and detailed description of the preferred embodiments of the invention.

### BRIEF DESCRIPTION OF THE DRAWINGS

FIG. 1 is a view in perspective of magnetizable or magnetic card, in which the card comprises a magnetizable or magnetic base member, an adhesive layer containing a plurality of non-adhesive voids or openings, and a release liner—or, optionally a scored release liner.

FIG. 2 is a view in perspective of an adhesive-backed magnetizable or magnetic article or card, wherein the article comprises a magnetizable or a magnetic base member, a printable sheet material non-magnetic surface affixed to the magnetizable or magnetic material, an adhesive layer adhered to the printable sheet material, and a backing or liner layer non-permanently bonded to the adhesive layer.

FIG. 2A is an alternative construction of the magnetizable or magnetic card with the adhesive layer in a novel form, comprising a magnetizable or magnetic base member, a printed surface layer, such as an advertisement, a removable adhesive layer containing a plurality of non-adhesive voids or openings, and a printed surface layer such as a coupon attached to the removable adhesive layer containing the plurality of non-adhesive voids or openings.

FIG. 3 shows one embodiment of an isolated view of the adhesive layer of FIG. 2 containing a plurality of non-adhesive voids or openings along one section of the adhesive to facilitate ease of peel and non-marring of the contact surface or printable layer.

FIG. 4 shows an embodiment of an isolated view of a scored or serrated adhesive layer of FIG. 2 additionally containing a plurality of non-adhesive voids or openings along two sections of the adhesive perimeter to facilitate ease of peel and non-marring of the contact surface or printable layer.

FIG. 5 shows an embodiment of an isolated view of a scored or serrated adhesive layer of FIG. 2 additionally containing a plurality of non-adhesive voids or openings along a section of the adhesive perimeter to facilitate ease of peel and non-marring of the contact surface or printable layer.

### DETAILED DESCRIPTION OF THE PREFERRED EMBODIMENT OF THE INVENTION

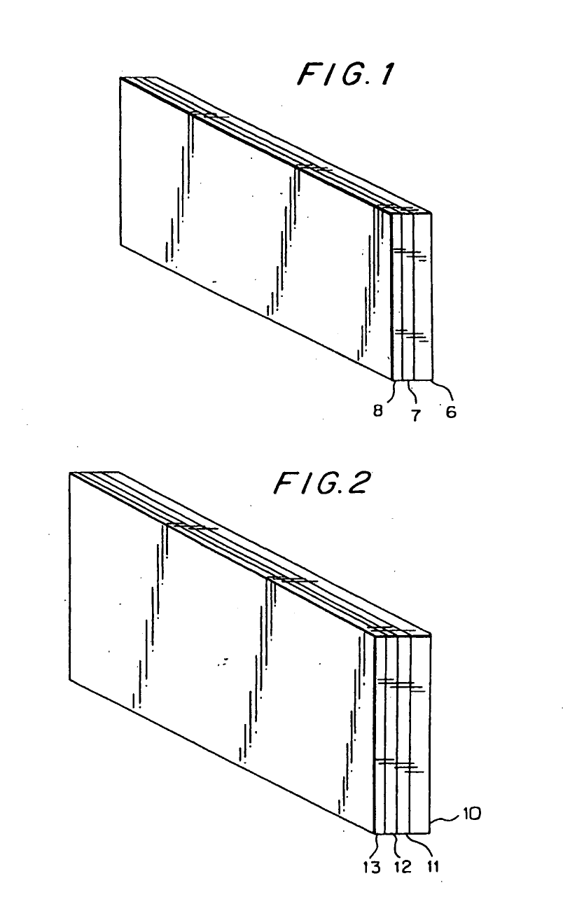

Referring now to FIG. 1, there is shown a magnetizable or magnetic card, which comprises a magnetizable or magnetic base member 6, an adhesive layer or adhesive layer with a carrier film 7 containing a plurality of non-adhesive voids or openings, and a release liner 8, which may be silicone coated. Voids in the adhesive layer enable a “tab” or grip in the release liner—thereby enabling the release liner to be gripped and easily removed. This magnetic card construction also serves to improve throughput of manufacturing operations. Further, it simplifies removal of the release liner when aggressive or very tacky adhesives are used, thereby enabling the adhesive to remain on the magnet when the release liner is removed. Additionally, when a multitude of separate magnets are used on a continuous liner in a modification of the construction of FIG. 1, the ease of release liner removal is enhanced proportionally.

FIG. 2 shows a view in perspective of an adhesive-backed magnetizable or magnetic article or card, wherein the card comprises a magnetizable or magnetic base member 10, a printable non-magnetic surface or layer 11 affixed to the magnetizable or magnetic layer, an adhesive layer 12, and a backing or liner layer 13 non-permanently bonded to the adhesive layer.

FIG. 2A is a perspective view of an alternative construction of the magnetizable or magnetic card with the adhesive layer in a novel form, comprising a magnetizable or magnetic base member 10a, a printed surface layer 11a, such as an advertisement, a removable adhesive layer containing a plurality of non-adhesive voids or openings 12a, and a printed surface layer 13a such as a coupon attached to the removable adhesive layer containing the plurality of non-adhesive voids or openings.

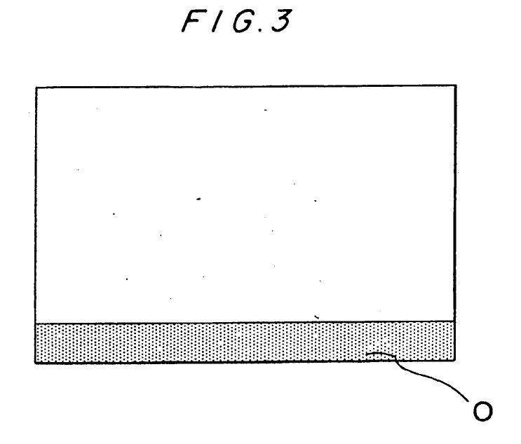

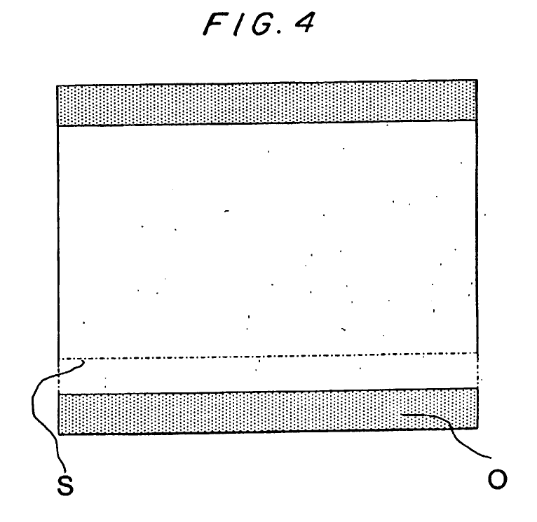

The innovation of the adhesive layer of the invention, may be seen by FIG. 3 which shows an isolated view of the adhesive layer 12 of FIG. 2 containing a plurality of non-adhesive voids or openings O along one section of the adhesive layer to facilitate ease of peel and non-marring of the contact surface or printable layer 11. The voids or openings may be throughout the entire width of the adhesive layer or only through a portion of the width of the adhesive layer.

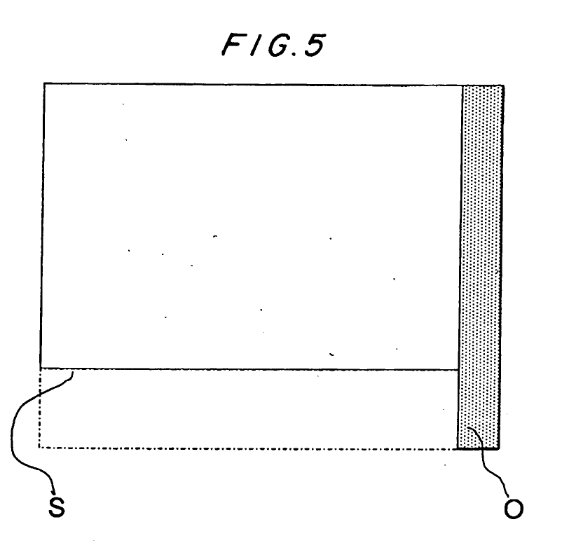

Another embodiment of the adhesive-backed magnetizable or magnetic article or card is that of FIG. 4 showing an isolated view of a scored or serrated section S of the adhesive layer of FIG. 2 additionally containing a plurality of non-adhesive voids or openings O along two sections of the adhesive perimeter to facilitate ease of peel and non-marring of the contact surface or printable layer 11. Again, the plurality of non-adhesive voids or openings may be throughout the width of the adhesive layer or only a portion of the width of the adhesive layer.

FIG. 5 depicts another embodiment of an isolated view of the adhesive layer of FIG. 2 that is scored or serrated section S and additionally containing a plurality of non-adhesive voids or openings O along a section of the adhesive perimeter to facilitate ease of peel and non-marring of the contact surface or printable layer. The plurality of non-adhesive voids or openings may be throughout the thickness of the adhesive layer or only a portion of the thickness of the adhesive layer.

The magnetic or magnetizable layer may be a viscoelastic layer that is a matrix comprised of any well known magnetic or magnetizable particles inclusive of barium ferrite, strontium ferrite, and an alloy magnetic substance employing Fe, Co, or Ni, or an alloy magnetic substance inclusive of but not limited to: AlNiCo, FeCrCo, NdFeB and SmCo. Typically, the size of these particles are about 2 microns and will constitute from about 70 to about 90% by weight of the matrix.

While the invention has been described by reference to specific embodiments, it is to be understood that many variations may be made without departing from the spirit and scope of the invention, which is limited only by the appended claims.

We claim:

1. In an adhesive-backed magnetizable article or card, the improvement wherein the article or card comprises:
a magnetizable base member;
a printable sheet material non-magnetic surface affixed to said magnetizable base member;
an adhesive layer containing a plurality of non-adhesive voids or openings to facilitate ease of peel and non-marring of the printable sheet material; and
a backing or liner layer non-permanently bonded to said adhesive layer.

2. The adhesive-backed magnetizable article of claim 1 wherein said plurality of non-adhesive voids or openings is disposed along one section of the adhesive.

3. The adhesive-backed magnetizable article of claim 1 wherein said plurality of non-adhesive voids or openings span only a portion of the thickness of said adhesive.

4. The adhesive-backed magnetizable article of claim 2 wherein said adhesive is additionally scored or serrated.

5. The adhesive-backed magnetizable article of claim 3 wherein said adhesive is additionally scored or serrated.

6. In an adhesive-backed magnetic article or card, the improvement wherein the article or card comprises:
a magnetic base member;
a printable sheet material non-magnetic surface affixed to said magnetic base member;
an adhesive layer containing a plurality of non-adhesive voids or openings to facilitate ease of peel and non-marring of the printable sheet material; and
a backing or liner layer non-permanently bonded to said adhesive layer.

7. The adhesive-backed magnetic article of claim 1 wherein said plurality of non-adhesive voids or openings is disposed along one section of the adhesive.

8. The adhesive-backed magnetic article of claim 6 wherein said plurality of non-adhesive voids or openings span only a portion of the thickness of said adhesive.

9. The adhesive-backed magnetic article of claim 8 wherein said adhesive is additionally scored or serrated.

10. The adhesive-backed magnetic article of claim 9 wherein said adhesive is additionally scored or serrated.

11. In an adhesive-backed magnetizable article or card, the improvement wherein the article or card comprises:
a magnetizable base member;
an adhesive layer containing a plurality of non-adhesive voids or openings to facilitate ease of peel of a release liner; and
a release liner disposed on said adhesive layer.

12. The adhesive-backed magnetizable article of claim 11 wherein the release liner is silicone coated.

13. The adhesive-backed magnetizable article of claim 12 wherein the adhesive layer further contains a carrier film.

14. In an adhesive-backed magnetic article or card, the improvement wherein the article or card comprises:
a magnetic base member;
an adhesive layer containing a plurality of non-adhesive voids or openings to facilitate ease of peel of a release liner; and
a release liner disposed on said adhesive layer.

15. The adhesive-backed magnetic article of claim 14 wherein the release liner is silicone coated.

16. The adhesive-backed magnetic article of claim 15 wherein the adhesive layer further contains a carrier film.

17. In an adhesive-backed magnetizable or magnetic article or card, the improvement wherein the article or card comprises:
a magnetizable or magnetic base member;
a first printed surface layer affixed to said magnetizable or magnetic base member;
a removable adhesive layer containing a plurality of non-adhesive voids or openings; and
a second printed surface layer attached to the removable adhesive layer containing the plurality of non-adhesive voids or openings.

18. The adhesive-backed magnetizable or magnetic article of claim 17 wherein said plurality of non-adhesive voids or openings is disposed along one section of the adhesive.

19. The adhesive-backed magnetizable or magnetic article of claim 17 wherein said plurality of non-adhesive voids or openings span only a portion of the thickness of said adhesive.

20. The adhesive-backed magnetizable or magnetic article of claim 18 wherein said adhesive is additionally scored or serrated.

21. The adhesive-backed magnetizable or magnetic article of claim 19 wherein said adhesive is additionally scored or serrated.

22. The adhesive-backed magnetizable or magnetic article of claim 17, wherein said first printed surface layer is an advertisement and said second printed surface layer attached to said adhesive layer is a coupon.
